(19) United States
(12) Patent Application Publication
(10) Pub. No.: US 2016/0246460 A1
(43) Pub. Date: Aug. 25, 2016

(54) METHOD AND APPARATUS FOR ARRANGING INSTANT MESSAGING WIDOWS

(71) Applicant: Tencent Technology (Shenzhen) Company Limited, Shenzhen (CN)

(72) Inventors: Jianbo CAO, Shenzhen (CN); Gang CHENG, Shenzhen (CN)

(21) Appl. No.: 15/144,594

(22) Filed: May 2, 2016

Related U.S. Application Data
(63) Continuation of application No. PCT/CN2014/090204, filed on Nov. 4, 2014.

(30) Foreign Application Priority Data
Nov. 7, 2013 (CN) 201310549515.2

(51) Int. Cl. G06F 3/0482; G06F 3/0486; H04L 12/58

(52) U.S. Cl. CPC G06F 3/0482; H04L 51/04; G06F 3/0486

(57) ABSTRACT

Method and device of arranging conversation interfaces of an instant messaging application are disclosed. The method includes: displaying a listing of conversation labels in a user interface of the instant messaging application, each conversation label having a respective position in the listing that corresponds to a respective rank of a respective instant messaging conversation in a conversation stack; receiving a first user instruction for moving a first conversation label in the listing from a first position in the listing to a second position in the listing; and in response to the first user instruction: moving the first conversation label from the first position to the second position in the listing; and moving a first conversation corresponding to the first conversation label from a first rank to a second rank in the conversation stack.

### PRIORITY CLAIM AND RELATED APPLICATION

This application is a continuation application of PCT Patent Application No. PCT/CN2014/0190204, entitled “METHOD AND APPARATUS FOR ARRANGING INSTANT MESSAGING WINDOWS” filed on Nov. 4, 2014, which claims priority to Chinese Patent Application No. 201310549515.2, entitled “METHOD AND APPARATUS FOR ARRANGING INSTANT MESSAGING WINDOWS” filed on Nov. 7, 2013, both of which are incorporated by reference in their entirety.

### FIELD OF THE TECHNOLOGY

This application relates to the field of Internet technologies, and in particular, to a method and an apparatus for arranging Instant Messaging (IM) interfaces.

### BACKGROUND OF THE TECHNOLOGY

Instant messaging applications provide people a fast and convenient way of connecting with each other. Popular instant messaging applications include WeChat. WhatsApp, Facebook messenger, LINE, Viber, Snapchat, QQ, MSN messenger, etc. Each of these instant messaging applications provide a community of users (senders and receivers) with the ability to communicate with numerous contacts and various relationships various relationship types, e.g., colleague, classmate, old buddy, virtual friend, family member, etc.

Currently, conversation interfaces (also referred to by different terms such as IM windows, chat windows, message interfaces, etc.) are arranged according to active states of the conversation interfaces. For example, the newest conversation interface is arranged at the top of the IM interface by default. This type of arrangement assumes either that the newest conversation is the most important conversation to a user (sender) or that the conversation is equally important and urgent for both users. However, when a user is engaged in multiple conversations, this type of arrangement makes it difficult for users to prioritize conversations.

Therefore, it is desirable to have a flexible method of arranging conversation interfaces to suit the preference of each user.

### SUMMARY

In accordance with some implementations of the disclosed technology, a method of arranging conversation interfaces of an instant messaging application, comprises: displaying a listing of conversation labels in a user interface of the instant messaging application, each conversation label having a respective position in the listing that corresponds to a respective rank of a respective instant messaging conversation in a conversation stack stored by the instant messaging application; receiving a first user instruction for moving a first conversation label in the listing from a first position in the listing to a second position in the listing; and in response to the first user instruction: moving the first conversation label from the first position in the listing to the second position in the listing; and moving a first conversation corresponding to the first conversation label from a first rank in the conversation stack corresponding to the first position in the listing to a second rank in the conversation stack corresponding to the second position in the listing.

In another aspect, a device comprises one or more processors, memory, and one or more program modules stored in the memory and configured for execution by the one or more processors. The one or more program modules include instructions for performing the method described above. In another aspect, a non-transitory computer readable storage medium having stored thereon instructions, which, when executed by a device, cause the device to perform the method described above.

### BRIEF DESCRIPTION OF THE DRAWINGS

The aforementioned features and advantages of the technology as well as additional features and advantages thereof will be more clearly understood hereinafter as a result of a detailed description of preferred embodiments when taken in conjunction with the drawings.

FIG. 1 is a flowchart of a method of moving conversation interfaces in accordance with some embodiments;

FIGS. 2a-2h are schematic diagrams showing different IM interfaces in accordance with some embodiments;

FIG. 3 is a structural diagram of an apparatus in accordance with some embodiments;

FIG. 4 is a flowchart of arranging conversation interfaces of an instant messaging application in accordance with some embodiments; and

FIG. 5 is a diagram of an example implementation of a device in accordance with some embodiments.

Like reference numerals refer to corresponding parts throughout the several views of the drawings.

### DESCRIPTION OF EMBODIMENTS

To make the objectives, technical solutions, and advantages more comprehensible, the present application is described in detail in the following with reference to the accompanying drawings and specific embodiments.

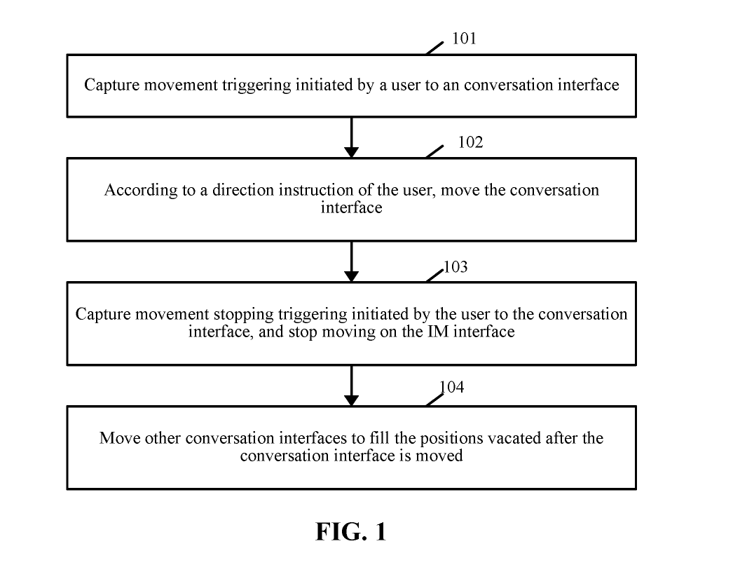

FIG. 1 is a flowchart of a method of moving conversation interfaces in accordance with some embodiments. As shown in FIG. 1, the method includes the following steps.

In accordance with some embodiments, in Step 101, a device captures movement triggering initiated by a user to a conversation interface on an IM interface.

In accordance with some embodiments, in Step 101, there are at least two implementation manners of capturing the movement triggering initiated by the user to the conversation interface on the IM interface.

In Manner 1, the capturing the movement triggering initiated by the user to the conversation interface on the IM interface includes:

detecting a touch operation executed by the user for the conversation interface on the IM interface with the smart device; and

when the touch operation executed by the user for the conversation interface on the IM interface is detected and the touch operation lasts for a set duration in the conversation interface, determining that the user initiates movement triggering to the conversation interface on the IM interface.

In this manner, the duration during which the user touches the conversation interface on the smart device may be set according to an actual condition, such as 1 second or another value.

Manner 2 is applied to a scenario of a terminal device having a triggering tool. The triggering tool includes a mouse.

In Manner 2, the capturing the movement triggering initiated by the user to the conversation interface on the IM interface includes:

detecting a triggering operation executed by the user for the conversation interface on the IM interface with the triggering tool of the terminal device; and

when the triggering operation executed by the user for the conversation interface on the IM interface is detected, determining that the user initiates movement triggering to the conversation interface on the IM interface.

When the action of the user clicking the conversation interface on the IM interface by using the mouse is captured, it indicates that the user initiates the movement triggering to the conversation interface on the IM interface. In some embodiments, the movement triggering includes dragging, or movement with arrow keys.

In accordance with some embodiments, in Step 102, the device moves the conversation interface according to a user instruction.

In some embodiments, each independent conversation interface on the IM interface is regarded as an independent unit. When it is found that movement triggering is initiated to one of the conversation interfaces, the conversation interface is moved according to the user instruction.

Specifically, if the movement triggering is dragging triggering, moving the conversation interface includes: capturing a dragging direction of the user dragging the conversation interface, and moving the conversation interface in the captured dragging direction on the IM interface.

If the movement triggering is the movement triggering with the arrow keys, moving the conversation interface includes:

capturing a moving direction of the user moving the conversation interface with the arrow keys, and moving the conversation interface in the captured moving direction on the IM interface.

In accordance with some embodiments, in Step 103, the device captures movement stopping triggering initiated by the user to the conversation interface on the IM interface, and control the conversation interface to stop moving on the IM interface.

Specifically, if the movement triggering is dragging, the movement stopping triggering in Step 103 is stopping dragging. If the movement triggering is the movement triggering with the arrow keys, the movement stopping triggering in Step 103 can be stopping triggering with arrow keys.

In accordance with some embodiments, in Step 104, the device moves other conversation interfaces to fill the positions vacated after the conversation interface is moved.

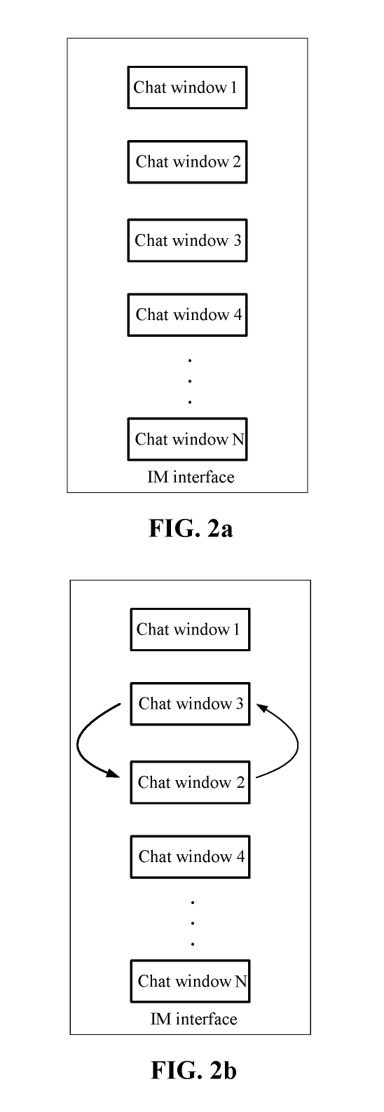

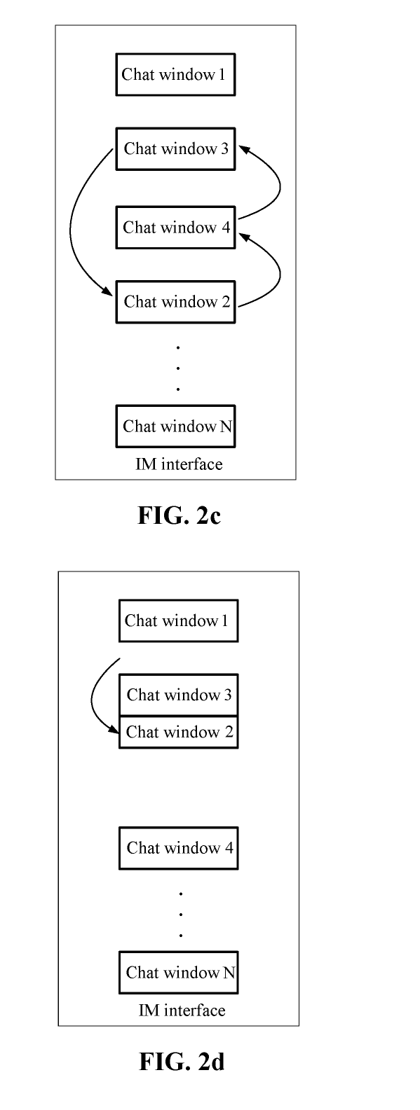

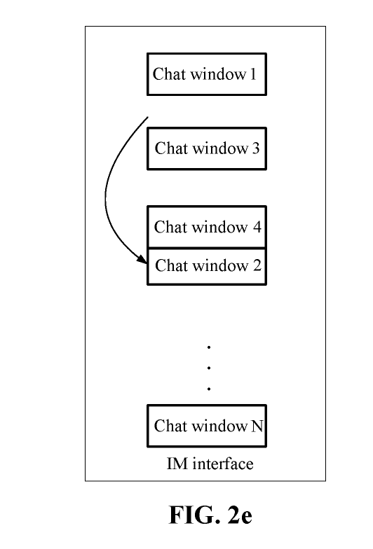

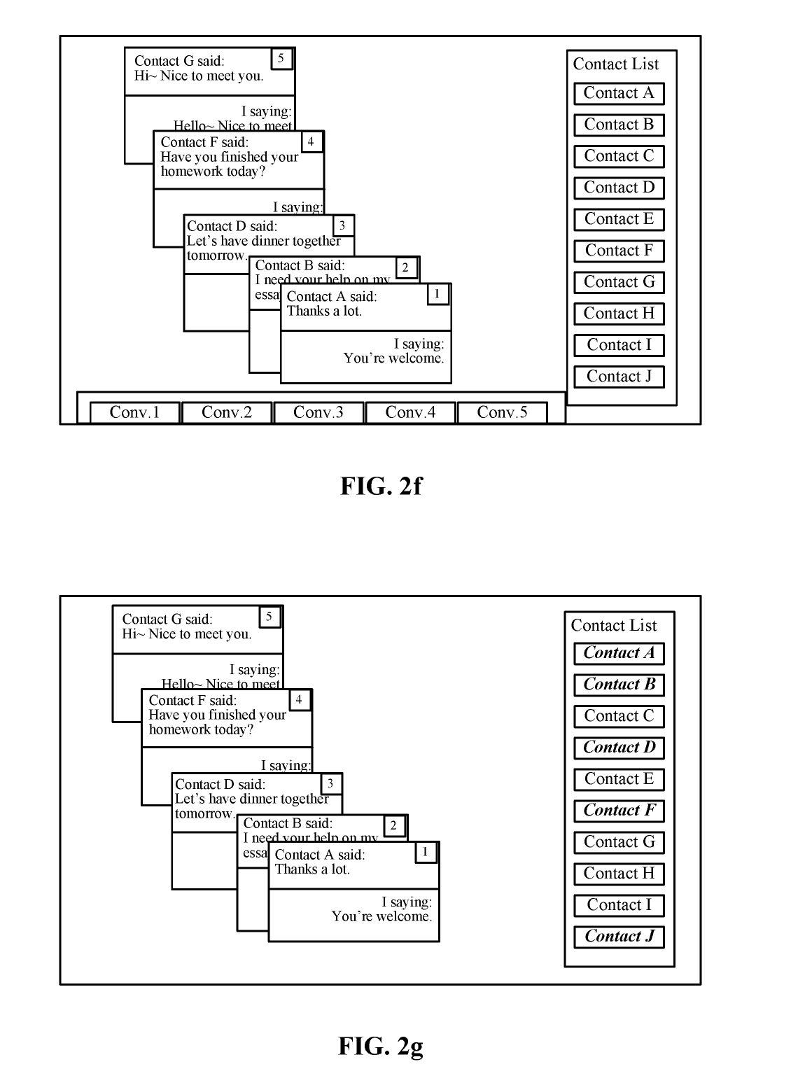

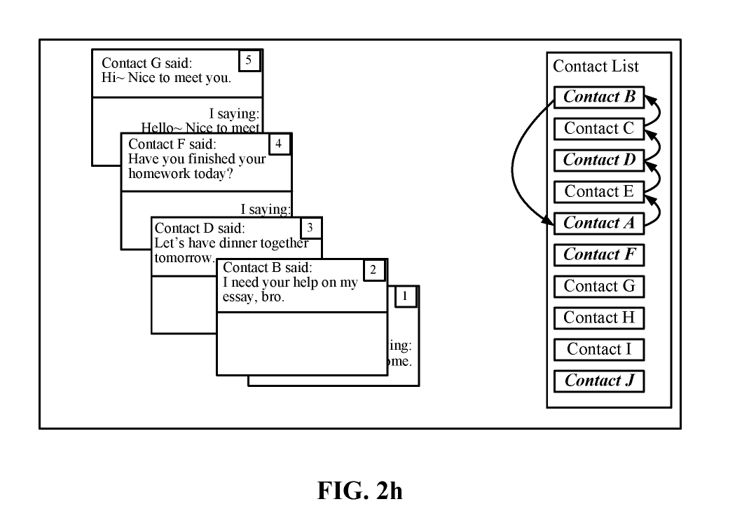

For example, in an IM interface shown in FIG. 2a, if the conversation interface 2 needs to be moved to a position of a conversation interface 3, a position 3 at which the conversation interface 3 is originally located is used as a current ending position, and a position 2 at which the conversation interface 2 is located before being moved is used as a current initial position. Since the position 2 serving as the current initial position is adjacent to the position 3 serving as the current ending position, after the conversation interface 2 moves to the position 3, the original conversation interface 3 at the position 3 moves to the position 2 at which the conversation interface 2 is located before being moved, as show in FIG. 2b.

For another example, in an IM interface shown in FIG. 2a, the conversation interface 2 needs to be moved to a position 4 at which the conversation interface 4 is originally located. Since the position 2 serving as the current initial position is not adjacent to the position 3 serving as the current ending position, after the conversation interface 2 moves to the position 4, the original conversation interface 3 at the position 3 moves to the position 2 at which the conversation interface 2 is located before being moved, and the original conversation interface 4 at the position 4 moves to the position 3 at which the conversation interface 3 is located before being moved, as show in FIG. 2c.

For example, in the IM interface shown in FIG. 2a, when the conversation interface 2 moves downwards and passes the conversation interface 3, the original position of the conversation interface 2, namely, the position 2 vacates as the conversation interface 2 moves. Then, the conversation interface 3 moves upwards to the position 2. Ultimately, the conversation interface 2 moves to the original position of the conversation interface 3. FIG. 2d is a schematic diagram showing that the conversation interface moves. FIG. 2b is a schematic diagram showing the arrangement of the conversation interfaces after the conversation interface 2 and the conversation interface 3 are moved.

For another example, in the IM interface shown in FIG. 2a, when the conversation interface 2 passes the conversation interface 3 when being moved downwards, the original position, the position 2 of the conversation interface 2 vacates as the conversation interface 2 moves. Then, the conversation interface 3 moves upwards to the position 2. When the conversation interface 2 continuously moves and passes the conversation interface 4, the original position of the conversation interface 3, vacates as the conversation interface 3 moves upwards before. The conversation interface 4 moves upwards to the position 3. Ultimately, the conversation interface 2 moves to original position of the conversation interface 4. FIG. 2e is a schematic diagram showing that the conversation interface moves. FIG. 2c is a schematic diagram showing the arrangement of the conversation interfaces after the conversation interface 2 and the conversation interface 4 are moved.

It should be noted that, in the foregoing description, the moved conversation interface includes a conversation interface name, a conversation interface ID, a conversation interface property, and part of a chat in the conversation interface.

In the foregoing description, a user moves a conversation interface on an IM interface as an independent object by capturing movement triggering initiated by the user; and stops moving the conversation interface on the IM interface by capturing movement stopping triggering initiated by the user, and moves other conversation interfaces to fill the positions.

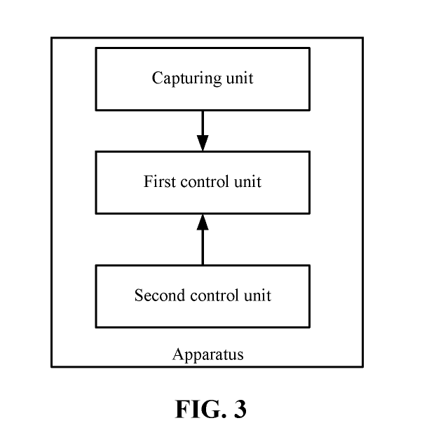

FIG. 3 is a structural diagram of an apparatus in accordance with some embodiments. The apparatus includes:

a capturing unit, configured to capture movement triggering initiated by a user movement stopping triggering initiated by the user;

a first control unit, configured to move the conversation interface as an object according to a user instruction moving the conversation interface; and

a second control unit, configured to move other conversation interfaces to till the positions vacating after the conversation interface is moved.

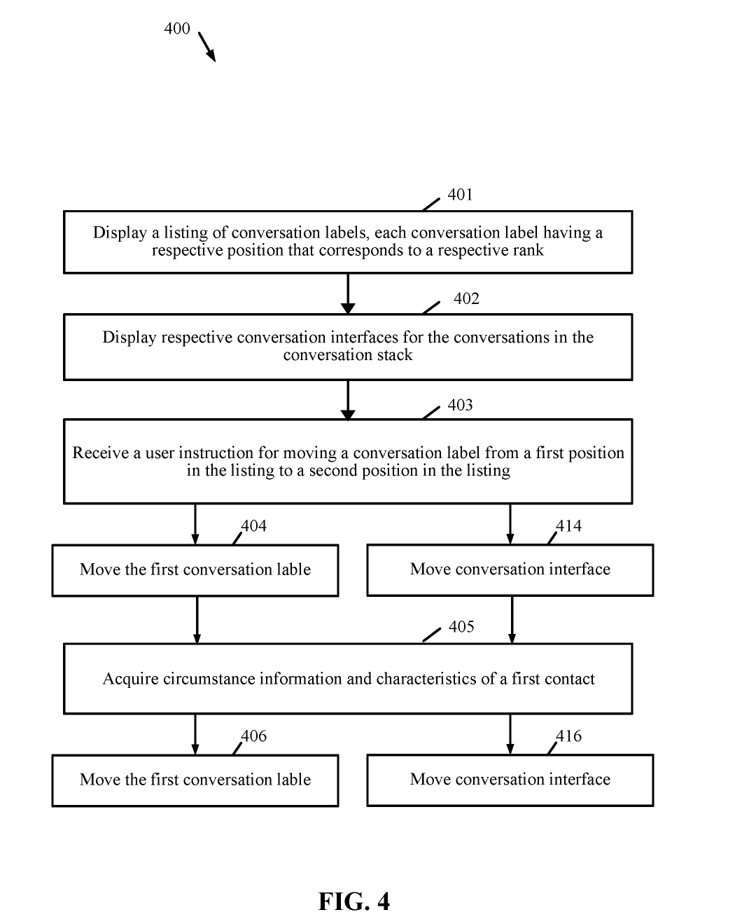

In accordance with some embodiments, FIG. 4 is a flowchart of a method 400 of arranging conversation interfaces of an instant messaging application. The method is performed at a device having one or more processors and memory for storing one or more programs to be executed by the one or more processors. The device can be a desktop computer, a laptop, a tablet, a mobile phone or a wearable device. The device can provide IM functions to users and provide an IM interface to receive and display instant messages

In accordance with some embodiments, in a step 401, the device displays a listing of conversation labels in a user interface of the instant messaging application, each conversation label having a respective position in the listing that corresponds to a respective rank of a respective instant messaging conversation in a conversation stack stored by the instant messaging application.

In some embodiments, a conversation is an interaction between the user and one or more contacts in the IM application. A conversation can be a message, an audio call, a video conference, a remote shaking of an IM window, document sharing, etc.

The “conversation stack” can include a stack that affects the order by which updates to the conversations are processed and presented to the user. The order in the conversation stack also affects how the conversation interfaces are rendered in the display (e.g., which ones are arranged on top of other ones).

In some embodiments, the listing of conversation labels is separate from the contact list. FIG. 2f illustrates a listing of conversation labels for conversations from number one to number five at the bottom of a screen.

In some embodiments, the listing of conversation labels is included in a contact list. For example, the contact list is displayed as a sequence of contact icons in a contact panel. FIG. 2g illustrates that a contact panel includes ten contacts, labeled A through J, but only five of the ten contacts have active conversations. The listing of conversation labels includes the icons of Contact A, Contact B, Contact D, Contact F and Contact G, corresponding to Conversation 1, Conversation 2, Conversation 3. Conversation 4, and Conversation 5, respectively. In some embodiments, not every contact in the contact list is necessarily located in the listing of conversation labels and not every contact icon corresponds to a rank in the respective instant messaging conversation. For example, User A has one hundred contacts in the contact list, five out of the one hundred contacts are having conversation with User A and thus the five contacts have corresponding conversation interfaces. Therefore, the listing of conversation labels has five conversation labels, and each conversation label is shown as a contact in the contact list.

In some embodiments, the conversation labels are the respective labels of conversation windows that are displayed to the user, and can selected by a user to open up or bring forward the particular dialogue for the corresponding conversation with one or more contacts. A conversation label can correspond to a conversation between the current user and one contact of the user, or it can correspond to a conversation between the current user and multiple contacts of the user (e.g., in a group chat). In some embodiments, unlike in FIGS. 2f-2h, the conversation labels are the only labels show in a display (e.g., a small display of a mobile phone), and the contact lists are not displayed in the same interface.

In some embodiments, the contacts in a contact list are ranked, e.g., from one to one hundred and the ranks of their conversations in the conversation stack reflects the ranks of the contacts in the contact list. A conversation of a higher ranked contact is ranked higher than a conversation of a lower ranked contact. For example, Contact B is ranked twenty three while Contact C is ranked thirty seven in a contact list of User D. When User D has two conversations with Contact B and Contact C, respectively, the conversation with Contact B is ranked number one while the conversation with Contact C is ranked number two. In some embodiments, for a group chat, the ranking of the conversation and corresponding conversation label reflects the ranking of the highest ranked contact involved in the group conversation, or the aggregated ranking of all contacts involved in the group conversation.

In accordance with some embodiments, a reminding policy for incoming messages in each conversation in the conversation stack is determined in accordance with the respective rank of the conversation in the conversation stack. For example, messages from higher ranked contacts jump out directly. Messages from lower ranked ones only change the color of the displayed contacts. For another example, a user may set the device in a way that when the device is displaying an application in a full-screen mode, e.g., displaying a movie, the only updating reminders that can be displayed are the ones from the conversations that are ranked within the top three ranks at the time the reminders were created.

In accordance with some embodiments, in a step 402, the device optionally displays respective conversation interfaces for the conversations in the conversation stack in accordance with an order of the corresponding conversation labels in the listing.

In some embodiments, a stack of conversation interfaces is displayed to the users, e.g., a stack of overlapping windows, or tabbed pages. In some embodiments, the stack is not displayed but affects the priority of the conversations in the stack being displayed or updated. For example, an IM application in a smart phone only displays one conversation interface at one time. Initially, the IM application displays conversation A that is ranked number one or on the top position. The user then wants to view another conversation, and either closes the conversation A or sends the conversation A to a lower rank. As a result, conversation B, which is next only to the conversation A in the rank, becomes the new top conversation. The IM application then displays the conversation B.

In some embodiments, as shown in FIGS. 2f and 2g, when two conversation interfaces overlap, and the one conversation interface is positioned in a higher rank in the stack than another conversation interface, the former conversation interface overlays at least part of the latter conversation interface.

In some embodiments, the conversation label list is separate from the conversation interfaces, and the two can be displayed concurrently. In addition, the conversation labels can also be a list shown on the device without the conversation interfaces being shown at the same time; and each label can be selected to show the corresponding conversation interface on the phone (without the listing being shown with the corresponding conversation interface). For example, a mobile phone displays only one conversation interface. When a user wants to see another conversation interface, the user can close the current conversation interface and replaces it with another one.

In some embodiments, the conversation label list can be hided or displayed in accordance with users' instructions. For example, when a user wants to adjust the ranks of conversations, he touches a button and the conversation label list is displayed. In some embodiments, the device determines whether to display the conversation label list in accordance with predetermined criteria. For example, the predetermined criteria include the position of the conversation label list when displayed, the number of conversations in the stack, the characteristics of the conversations, etc. For example, the default setting could be that when there are more than six active conversations, the device automatically displays the conversation label list. When there are less than four active conversations, the device automatically hides the conversation label list.

In accordance with some embodiments, in a step 403, the device receives a first user instruction for moving a first conversation label in the listing from a first position in the listing to a second position in the listing.

A user can provide the instruction in multiple ways. The user instruction can be a user input for dragging and dropping the first conversation label from the first position to the second position in the listing. The user can also select one conversation label and uses keyboards to change its position, such as pressing “left,” “tab,” “down,” “page down.”

In accordance with some embodiments, in response to the first user instruction, the device performs steps 404 and 414.

In accordance with some embodiments, in the step 404, the device moves the first conversation label from the first position in the listing to the second position in the listing; and, in the step 414, the device moves a first conversation corresponding to the first conversation label from a first rank in the conversation stack corresponding to the first position in the listing to a second rank in the conversation stack corresponding to the second position in the listing.

FIG. 2h illustrates the device moving a conversation label for Conversation 1 and its corresponding conversation. The device initially displays an IM application as shown in FIG. 2g. The user selects Contact A and drags it to the original position of Contact E. Contacts B to E then move up to fill the vacated positions. Since Contact A corresponds to Conversation 1, the dragging moves the conversation label of Conversation 1 to a position that is between a conversation label of Conversation 3 (Contact D) and a conversation label of Conversation 4 (Contact F). As a result. Conversation 2 (Contact B) moves to rank number one, Conversation 3 (Contact D) moves to rank number two; and Conversation 1 (Contact A) moves to rank number three. In FIG. 2h, the conversation interface of Conversation 1 is covered by the conversation interface of Conversation 2.

In accordance with some embodiments, the user instruction includes moving more than one conversation label from one position to another in the listing. In some embodiments, the device receives a second user instruction for moving the respective conversation label associated with the first contact in the listing. The user instruction can be a user input dragging and dropping one of the plurality of contacts in the listing from one position to a different position in the listing. A user can selects a user group including the first conversation label and moves the user group together. The user instruction may include moving a whole pre-assigned contact group or a plurality of conversation labels selected by the user.

In accordance with some embodiments, the device assigns at least a first contact and a second contact associated with a user of the device into a respective group. In some embodiments, the first and second contacts each have a corresponding instant messaging conversation with the user, and each of the corresponding conversations is associated with a respective conversation label in the listing. In some embodiments, the first and second contacts do not have conversation instant messaging conversation with the user at the time of the assigning.

There can be more than two in the group. The assigning can be done at the user's instruction or automatically based on some predetermined grouping criteria (e.g., relationship with the user, location, etc.). The grouping can change based on the current time and location. The grouping can also change based on other factors, such as the user's online status (e.g., busy, online, available, happy, sad, etc.). In some embodiments, a contact can belong to multiple groups based on its multiple characteristics. For example, Contact A, whose online status is online and active, is assigned to “active” group. The contact A is also a colleague of the user, and belongs to “colleague” group. At last, the contact A shares a passion of skiing with the user and belongs to “ski interest” group.

In some embodiments, all conversations are displayed in one stack. In some embodiments, there are multiple conversation stacks and each stack corresponds to a group. When each group has its own conversation stack, the user can move a conversation of a contact with the stack. The user can also move the whole group up or down in the contact list and/or the conversation label list. When the user moves the whole group, all conversation labels of the group move with the group.

In accordance with some embodiments, in response to the second user instruction: the device concurrently moving the respective conversation labels associated with the first and second contacts in the listing, such that relative positions of the respective labels associated with the first and second contacts in the listing remain unchanged; and moves the respective conversations corresponding the respective conversation labels associated with the first and second contacts in the conversation stack in accordance with new positions of the respective conversation labels in the listing. Therefore, when the user moves multiple conversation labels, all conversations corresponding to the multiple conversation labels move as well. In addition, each of the conversation moves to a new rank corresponding to the new position of the respective corresponding conversation label. For example, Group H has two conversations, 6 and 7. Originally, Group H is in a position above a conversation label 3 and therefore, both conversations 6 and 7 are in positions above the conversation label 3. Then the device moves Group H to a position below the conversation label 3 and therefore, both conversations 6 and 7 are moved to positions below the conversation label 3. However, the relative positions of conversation 6 and conversation 7 remains unchanged by the moving. If conversation 6 is positioned higher than the conversation 7 before the device moving Group H, the conversation 6 remains to be higher than the conversation 7 after the moving.

In accordance with some embodiments, the device receives a user input that reorders a first conversation interface and a second conversation interface of the displayed respective conversation interfaces; and in response to and in accordance with the user input: reorders the respective conversations corresponding to the first and second conversation interfaces in the conversation stack and the respective conversation labels corresponding to the first and second conversation interfaces in the listing. For example, there are multiple conversation interfaces displayed in a screen, a user has not finished conversation but decides to postpone the conversation. The user selects the conversation by right-clicking it and sends it to a lower rank, e.g., the bottom of the stack. The conversation label of the conversation also moves to a position with the lowest rank. When a user wants to pick up the conversation, he can moves the conversation label back to a higher rank. Alternatively, after the user finishes and closes all other conversations, the postponed conversation will emerge to the top again. In this way, the positions of conversation labels move with the ranks of conversation interfaces.

In accordance with some embodiments, sometimes, each conversation correspond to one contact; sometimes, conversation can correspond to multiple contacts (e.g., in a group conversation); and sometimes, multiple conversations correspond to one contact, (e.g., a contact is both sending messages and talking over an audio call).

In accordance with some embodiments, in a step 405, the device acquires circumstance information and characteristics of a first contact associated with a user of the device. In some embodiments, the first contact has a corresponding instant messaging conversation with the user, and the corresponding conversation is associated with a respective conversation label in the listing.

In some embodiments, the circumstance information includes one or more of groupings of a current time, a current location of the device, one or more applications currently running on the device, and one or more applications currently being displayed on the device.

In some embodiments, characteristics of the first contact include one or more of groupings of a relationship between the user and the first contact, a current online status of the first contact, a respective group that first contact is assigned to, a time of a latest message received from the first contact, a current conversation status of the first contact, and a current location of the first contact.

In accordance with some embodiments, in steps 406 and 416, in accordance with the circumstance information and the characteristics of the first contact, the device automatically updates a respective position of the respective conversation label for the conversation between the first contact and the user in the listing; and automatically updates a respective rank of the conversation between the first contact and the user in the conversation stack.

For example, when the circumstance information indicates that the current time is working time during a day, and the characteristics of Contact C indicate that Contact C is a colleague, the IM application enhances the ranks of conversations of Contact C in a conversation stack. As a result, the conversation with Contact C receives higher priority during working time.

For another example, Contact D sends a message to user A and then goes offline, the IM application decreases the rank of Contact D in a conversation stack after Contact D goes offline (e.g., the rank of Contact being enhanced with a whole “colleague” group). As a result, replying the message of Contact D is assigned to a lower urgency because of Contact D is currently unavailable to read the reply.

For still another example, user A is using MATLAB, a research software program, and the characteristics of Contact E indicates that Contact E is a friend in “ski interest group,” the IM application decreases the rank of a conversation of Contact E in the listing of conversation labels. As a result, when user A is working, the messages from a hobby group are assigned to a lower priority.

For yet another example, User E initiates a video call with the user. The IM application increases the video call to the top, over other message conversations. The nature of the conversation, a video call, increases the rank of Contact E in the listing of conversation labels.

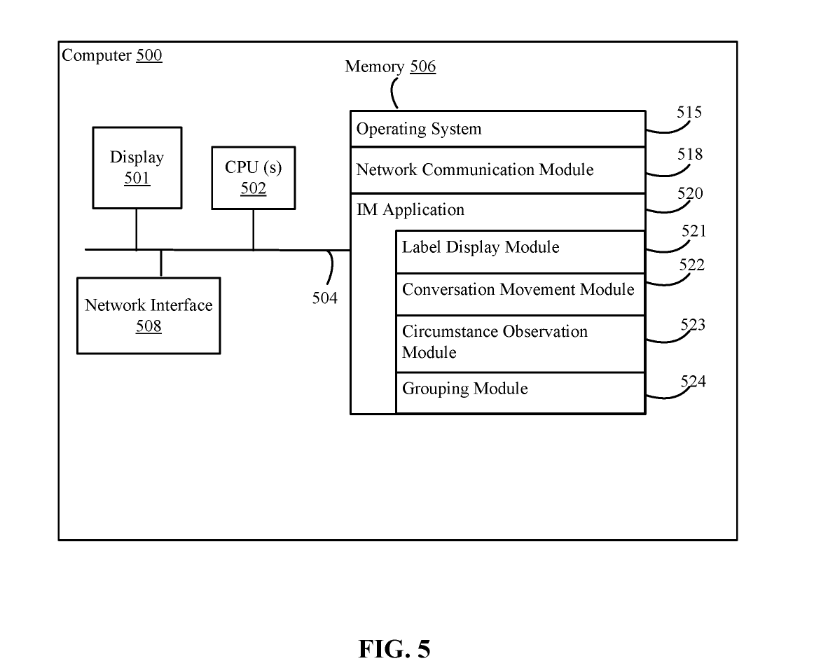

FIG. 5 is a diagram of an example implementation of a device 500 in accordance with some embodiments. While certain specific features are illustrated, those skilled in the art will appreciate from the present disclosure that various other features have not been illustrated for the sake of brevity and so as not to obscure more pertinent aspects of the implementations disclosed herein. To that end, the device 500 includes one or more processing units (CPU's) 502, one or more network or other communications interfaces 508, a display 501, memory 506, and one or more communication buses 504 for interconnecting these and various other components. The communication buses may include circuitry (sometimes called a chipset) that interconnects and controls communications between system components. The memory 506 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 506 may optionally include one or more storage devices remotely located from the CPU(s) 502. The memory 506, including the non-volatile and volatile memory device(s) within the memory 506, comprises a non-transitory computer readable storage medium.

In some implementations, the memory 506 or the non-transitory computer readable storage medium of the memory 506 stores the following programs, modules and data structures, or a subset thereof including an operating system 516, a network communication module 518, and an IM application 520.

In accordance with some embodiments, the operating system 516 includes procedures for handling various basic system services and for performing hardware dependent tasks.

In accordance with some embodiments, the network communication module 518 facilitates communication with other devices via the one or more communication network interfaces 508 (wired or wireless) and one or more communication networks, such as the internet, other wide area networks, local area networks, metropolitan area networks, and so on.

In accordance with some embodiments, the IM application 520 provides functions including IM conversation, contact management, and so on. In some embodiments, the IM application 520 comprises, inter alia, a label display module 521, a conversation movement module 522, a circumstance observation module 523 and a grouping module 524. The label display module 521 is configured to display conversation labels in a listing. The conversation movement module 522 is configured to move ranks of conversations in a stack in and move the positions of conversation labels in the listing. The circumstance observation module 523 is configured to acquire circumstance information, determine movements of the conversation labels in accordance with the acquired circumstance information, and instruct the conversation module 522 to move the conversation labels in accordance with the determination. The grouping module 524 is configured to group contacts and/or conversation labels together so that a group of contacts and/or conversation labels can move together in the listing.

While particular embodiments are described above, it will be understood it is not intended to limit the application to these particular embodiments. On the contrary, the technology includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the technology to the precise forms disclosed. Many modifications and variations are possible in view of the above teachings. The embodiments were chosen and described in order to best explain the principles of the technology and its practical applications, to thereby enable others skilled in the art to best utilize the technology and various embodiments with various modifications as are suited to the particular use contemplated.

What is claimed:

1. A method of arranging conversation interfaces of an instant messaging application, comprising:
at a device having one or more processors and memory for storing one or more programs to be executed by the one or more processors:
displaying a listing of conversation labels in a user interface of the instant messaging application, each conversation label having a respective position in the listing that corresponds to a respective rank of a respective instant messaging conversation in a conversation stack stored by the instant messaging application;
receiving a first user instruction for moving a first conversation label in the listing from a first position in the listing to a second position in the listing; and
in response to the first user instruction:
moving the first conversation label from the first position in the listing to the second position in the listing; and
moving a first conversation corresponding to the first conversation label from a first rank in the conversation stack corresponding to the first position in the listing to a second rank in the conversation stack corresponding to the second position in the listing.

2. The method of claim 1, further comprising:
assigning at least a first contact and a second contact associated with a user of the device into a respective group, wherein the first and second contacts each have a corresponding instant messaging conversation with the user, and each of the corresponding conversations is associated with a respective conversation label in the listing;
receiving a second user instruction for moving the respective conversation label associated with the first contact in the listing; and
in response to the second user instruction:
concurrently moving the respective conversation labels associated with the first and second contacts in the listing, such that relative positions of the respective labels associated with the first and second contacts in the listing remain unchanged; and
moving the respective conversations corresponding the respective conversation labels associated with the first and second contacts in the conversation stack in accordance with new positions of the respective conversation labels in the listing.

3. The method of claim 1, further comprising:
acquiring circumstance information and characteristics of a first contact associated with a user of the device, wherein the first contact has a corresponding instant messaging conversation with the user, and the corresponding conversation is associated with a respective conversation label in the listing; and
in accordance with the circumstance information and the characteristics of the first contact:
automatically updating a respective position of the respective conversation label for the conversation between the first contact and the user in the listing; and
automatically updating a respective rank of the conversation between the first contact and the user in the conversation stack.

4. The method of claim 3, wherein the circumstance information includes one or more of groupings of a current time, a current location of the device, one or more applications currently running on the device, and one or more applications currently being displayed on the device.

5. The method of claim 3, wherein characteristics of the first contact include one or more of groupings of a relationship between the user and the first contact, a current online status of the first contact, a respective group that first contact is assigned to, a time of a latest message received from the first contact, a current conversation status of the first contact, and a current location of the first contact.

6. The method of claim 1, further comprising:
displaying, concurrently with the listing of conversation labels, respective conversation interfaces for the conversations in the conversation stack in accordance with an order of the corresponding conversation labels in the listing;
receiving a user input that reorders a first conversation interface and a second conversation interface of the displayed respective conversation interfaces; and
in response to and in accordance with the user input:
reordering the respective conversations corresponding to the first and second conversation interfaces in the conversation stack; and
reordering the respective conversation labels corresponding to the first and second conversation interfaces in the listing.

7. The method of claim 1, wherein a reminding policy for incoming messages in each conversation in the conversation stack is determined in accordance with the respective rank of the conversation in the conversation stack.

8. A device of arranging conversation interfaces of an instant messaging application, comprising:
one or more processors; and
memory for storing one or more programs to be executed by the one or more processors:
displaying a listing of conversation labels in a user interface of the instant messaging application, each conversation label having a respective position in the listing that corresponds to a respective rank of a respective instant messaging conversation in a conversation stack stored by the instant messaging application;
receiving a first user instruction for moving a first conversation label in the listing from a first position in the listing to a second position in the listing; and
in response to the first user instruction:
moving the first conversation label from the first position in the listing to the second position in the listing; and
moving a first conversation corresponding to the first conversation label from a first rank in the conversation stack corresponding to the first position in the listing to a second rank in the conversation stack corresponding to the second position in the listing.

9. The device of claim 8, wherein the operations further comprise:
assigning at least a first contact and a second contact associated with a user of the device into a respective group, wherein the first and second contacts each have a corresponding instant messaging conversation with the user, and each of the corresponding conversations is associated with a respective conversation label in the listing;
receiving a second user instruction for moving the respective conversation label associated with the first contact in the listing; and
in response to the second user instruction:
concurrently moving the respective conversation labels associated with the first and second contacts in the listing, such that relative positions of the respective labels associated with the first and second contacts in the listing remain unchanged; and
moving the respective conversations corresponding the respective conversation labels associated with the first and second contacts in the conversation stack in accordance with new positions of the respective conversation labels in the listing.

10. The device of claim 8, wherein the operations further comprise:
acquiring circumstance information and characteristics of a first contact associated with a user of the device, wherein the first contact has a corresponding instant messaging conversation with the user, and the corresponding conversation is associated with a respective conversation label in the listing; and
in accordance with the circumstance information and the characteristics of the first contact:
automatically updating a respective position of the respective conversation label for the conversation between the first contact and the user in the listing; and
automatically updating a respective rank of the conversation between the first contact and the user in the conversation stack.

11. The device of claim 10, wherein the circumstance information includes one or more of groupings of a current time, a current location of the device, one or more applications currently running on the device, and one or more applications currently being displayed on the device.

12. The device of claim 10, wherein characteristics of the first contact include one or more of groupings of a relationship between the user and the first contact, a current online status of the first contact, a respective group that first contact is assigned to, a time of a latest message received from the first contact, a current conversation status of the first contact, and a current location of the first contact.

13. The device of claim 8, wherein the operations further comprise:
displaying, concurrently with the listing of conversation labels, respective conversation interfaces for the conversations in the conversation stack in accordance with an order of the corresponding conversation labels in the listing;
receiving a user input that reorders a first conversation interface and a second conversation interface of the displayed respective conversation interfaces; and
in response to and in accordance with the user input:
reordering the respective conversations corresponding to the first and second conversation interfaces in the conversation stack; and
reordering the respective conversation labels corresponding to the first and second conversation interfaces in the listing.

14. The device of claim 8, wherein a reminding policy for incoming messages in each conversation in the conversation stack is determined in accordance with the respective rank of the conversation in the conversation stack.

15. A non-transitory computer readable storage medium having instructions stored thereon, the instructions, when executed by one or more processors, cause the processors to perform operations comprising:
displaying a listing of conversation labels in a user interface of the instant messaging application, each conversation label having a respective position in the listing that corresponds to a respective rank of a respective instant messaging conversation in a conversation stack stored by the instant messaging application;
receiving a first user instruction for moving a first conversation label in the listing from a first position in the listing to a second position in the listing; and
in response to the first user instruction:
moving the first conversation label from the first position in the listing to the second position in the listing; and
moving a first conversation corresponding to the first conversation label from a first rank in the conversation stack corresponding to the first position in the listing to a second rank in the conversation stack corresponding to the second position in the listing.

16. The non-transitory computer readable storage medium of claim 15, wherein the operations further comprise:
assigning at least a first contact and a second contact associated with a user of the device into a respective group, wherein the first and second contacts each have a corresponding instant messaging conversation with the user, and each of the corresponding conversations is associated with a respective conversation label in the listing;
receiving a second user instruction for moving the respective conversation label associated with the first contact in the listing; and
in response to the second user instruction:
concurrently moving the respective conversation labels associated with the first and second contacts in the listing, such that relative positions of the respective labels associated with the first and second contacts in the listing remain unchanged; and
moving the respective conversations corresponding the respective conversation labels associated with the first and second contacts in the conversation stack in accordance with new positions of the respective conversation labels in the listing.

17. The non-transitory computer readable storage medium of claim 15, wherein the operations further comprise:
acquiring circumstance information and characteristics of a first contact associated with a user of the device, wherein the first contact has a corresponding instant messaging conversation with the user, and the corresponding conversation is associated with a respective conversation label in the listing; and
in accordance with the circumstance information and the characteristics of the first contact:
automatically updating a respective position of the respective conversation label for the conversation between the first contact and the user in the listing; and
automatically updating a respective rank of the conversation between the first contact and the user in the conversation stack.

18. The non-transitory computer readable storage medium of claim 17, wherein the circumstance information includes one or more of groupings of a current time, a current location of the device, one or more applications currently running on the device, and one or more applications currently being displayed on the device.

19. The non-transitory computer readable storage medium of claim 17, wherein characteristics of the first contact include one or more of groupings of a relationship between the user and the first contact, a current online status of the first contact, a respective group that first contact is assigned to, a time of a latest message received from the first contact, a current conversation status of the first contact, and a current location of the first contact.

20. The non-transitory computer readable storage medium of claim 15, wherein the operations further comprise:
displaying, concurrently with the listing of conversation labels, respective conversation interfaces for the conversations in the conversation stack in accordance with an order of the corresponding conversation labels in the listing;
receiving a user input that reorders a first conversation interface and a second conversation interface of the displayed respective conversation interfaces; and
in response to and in accordance with the user input:
reordering the respective conversations corresponding to the first and second conversation interfaces in the conversation stack; and
reordering the respective conversation labels corresponding to the first and second conversation interfaces in the listing.
